(19) United States
(12) Patent Application Publication
(10) Pub. No.: US 2014/0162837 A1
(43) Pub. Date: Jun. 12, 2014

(54) Method for Activating a Hybrid Drive of a Vehicle

(71) Applicants: Markus Eisele, Friedrichshafen (DE); Yvonne Wiegand, Nürnberg (DE)

(72) Inventors: Markus Eisele, Friedrichshafen (DE); Yvonne Wiegand, Nürnberg (DE)

(21) Appl. No.: 14/130,722

(22) PCT Filed: Jun. 14, 2012
(86) PCT No.: PCT/EP2012/061302

§ 371 Date: Jan. 3, 2014

(30) Foreign Application Priority Data
Jul. 5, 2011 (DE) 10 2011 078 669.4

(51) Int. Cl. B60W 20/00

(52) U.S. Cl. CPC B60W 20/10; Y10S 903/902
USPC 477/3; 180/65.265; 903/902

(57) ABSTRACT

A method for controlling a hybrid drive of a vehicle is provided, for which a target drive torque (T_{target}) is provided by the internal combustion engine or the electrical engine, as the case may be, depending on an accelerator pedal position (AP) through a stored accelerator pedal characteristic curve for the drive of the vehicle. Upon a recognized driver's request for emission-free driving, the accelerator pedal characteristic curve is adjusted in such a manner that the maximum target drive torque (T_{target}) corresponds to the maximum electrical engine drive torque (T_{E-max}).

### FIELD OF THE INVENTION

The present invention relates to a method for controlling a hybrid drive of a vehicle wherein a target drive torque (T_{target}) is provided by an internal combustion engine or electrical engine, as the case may be, depending on an accelerator pedal position (AP) through a stored accelerator pedal characteristic curve for the drive of the vehicle.

### BACKGROUND

As an example, publication DE 10 2006 012 515 A1 discloses a motor vehicle with a hybrid drive. The motor vehicle comprises two drive units for the generation of the drive torque, whereas the drive units can be operated both jointly and separately for the generation of the drive torque. In addition, a device for submitting a driver's request, along with a control unit for processing the driver's request and for generating control signals for the control of the drive units, are provided.

As an example, with such a parallel hybrid drive in the so-called “hybrid drive,” both an internal combustion engine drive torque and an electrical engine drive torque can be used. If, for example, the electrical engine drive torque is not sufficient for achieving the desired target drive torque, the internal combustion engine drive torque can also be used for support, in order to achieve the desired vehicular acceleration or vehicular speed. However, if the drive torque of the electrical drive is sufficient, it can be driven purely on electricity, and the internal combustion engine can be turned off in order to conserve fuel and drive emission-free. The driver's request torque, which corresponds to the target drive torque, is derived from the accelerator pedal placement or the accelerator pedal position through an accelerator pedal characteristic curve. An accelerator pedal area thus arises, in which the vehicle is driven purely on electricity if the driver's request torque is less than or equal to the maximum electrical engine drive torque, and there is an area in which the internal combustion engine drive torque is also required, if the driver's request torque is greater than the maximum possible electrical drive torque.

Known methods for the control of the hybrid drive show that the driver can use only a small part of the accelerator pedal area, if the vehicle is to be driven emission-free in, for example, inner-city areas. This is the case, since the internal combustion engine is automatically engaged, and thus unwanted emissions are produced as soon as the driver selects a target drive torque that is greater than the maximum electrical engine drive torque.

### SUMMARY OF THE INVENTION

The present invention is subject to the task of proposing a method of the type described above that, when necessary, ensures driving that is as comfortable and emission-free as possible. Additional objects and advantages of the invention will be set forth in part in the following description, or may be obvious from the description, or may be learned through practice of the invention.

In accordance with the invention, this task is solved by the characteristics of the claimed invention.

Accordingly, what is proposed is a method for controlling a hybrid drive, for example a parallel hybrid or the like, for which, through corresponding control equipment, such as a control device or the like, a target drive torque is provided by the internal combustion engine or the electrical engine, as the case may be, depending on an accelerator pedal position through a stored, standard accelerator pedal characteristic curve for the drive of the vehicle. In order to realize emission-free driving of the vehicle, thus driving without drive torque from the internal combustion engine, when a driver's request for emission-free driving is recognized, the standard, originally stored accelerator pedal characteristic curve may be adjusted in such a manner that the maximum target drive torque corresponds to the maximum possible electrical engine drive torque.

In this manner, it is possible that, with the assistance of the method under the invention, the vehicle is solely electrically driven through the transmission of the driver's request for emission-free driving, such that the internal combustion engine is turned off and the vehicle is driven without producing emissions.

In order to be able to realize this with safety and comfort, the standard accelerator pedal characteristic curve is adjusted, such that the accelerator pedal placement or accelerator pedal position is correspondingly reinterpreted. For example, the accelerator pedal characteristic curve for purely electric driving can be transformed in such a manner that the area of hybrid driving is virtually eliminated.

Accordingly, a very simple embodiment of the present invention may provide that the adjusted accelerator pedal characteristic curve with respect to the slope based on the stored accelerator pedal characteristic curve remains largely unchanged, but is virtually cut off above the maximum target drive torque of the electrical drive, such that the switching on of the internal combustion engine drive is also eliminated if the driver chooses an accelerator pedal position of up to 100%. This results in the advantage that the driving experience for the driver, which is produced by the stored accelerator pedal characteristic curve, is maintained, as the relationship between the acceleration and the accelerator pedal placement is, based on the unchanged gradients in the adjusted accelerator pedal characteristic curve, maintained.

In accordance with a further embodiment of the invention, it may also be provided that, within the framework of the proposed method, an adjusted accelerator pedal characteristic curve is stored, which uses the entire accelerator pedal area for purely electric driving, by virtually carrying out a rescaling. Thereby, with the adjusted accelerator pedal characteristic curve, the gradient is changed, compared to the originally stored accelerator pedal characteristic curve, in such a manner that a value of approximately 100% of the accelerator pedal position is allocated, as a maximum target drive torque, to the maximum electrical engine drive torque. Thus, given the flatter gradient, the driving experience for the driver with the adjusted accelerator pedal characteristic curve is more sensitive, because the relationship between the acceleration behavior and the accelerator pedal position is correspondingly changed. Since the entire accelerator pedal area is used, in an advantageous manner, there are no dead areas in the control.

The present invention is further discussed on the basis of the drawings. The following is shown:

### BRIEF DESCRIPTION OF THE DRAWINGS

FIG. 1 is a diagram with a course of the target drive torque over the accelerator pedal position according to a first method embodiment under the invention for controlling a hybrid drive of a vehicle; and

FIG. 2 is a diagram with a course of the target drive torque over the accelerator pedal position according to a second method embodiment under the invention.

### DETAILED DESCRIPTION

Reference will now be made to embodiments of the invention, one or more examples of which are shown in the drawings. Each embodiment is provided by way of explanation of the invention, and not as a limitation of the invention. For example features illustrated or described as part of one embodiment can be combined with another embodiment to yield still another embodiment. It is intended that the present invention include these and other modifications and variations to the embodiments described herein.

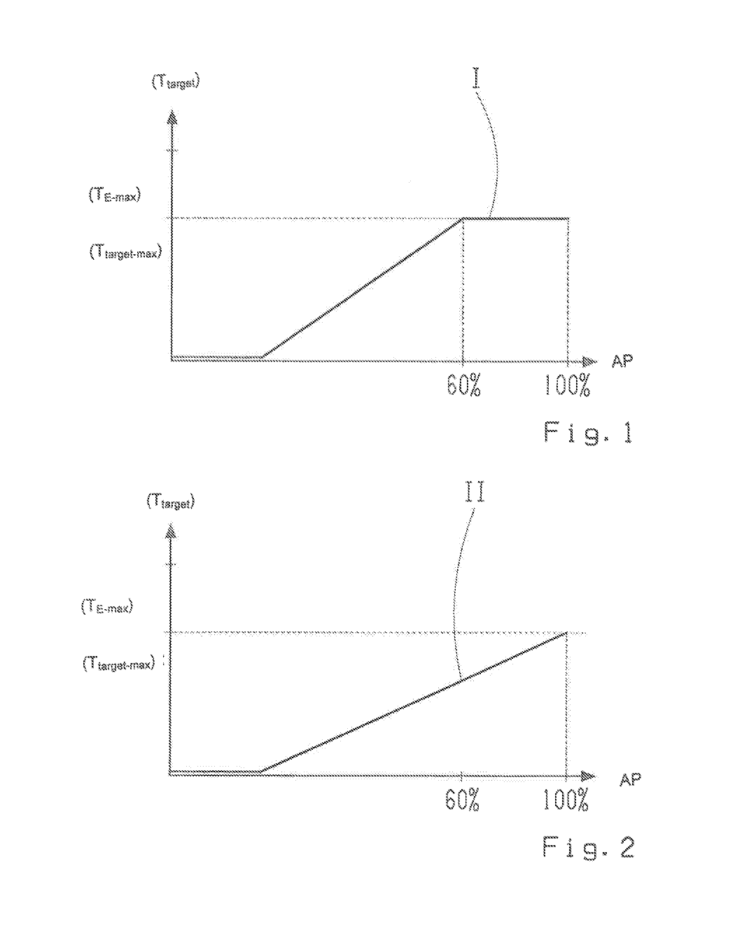

FIGS. 1 and 2 show diagrams with adjusted accelerator pedal characteristic curves I and II, shown as examples, which are used within the framework of the method under the invention for controlling a hybrid drive of a vehicle.

With hybrid drives, there is the option of driving a vehicle with the internal combustion engine or the electrical engine, and in combination with both drives. Since, as a rule, the internal combustion engine can be turned on with there is insufficient electrical torque, areas in which a so-called “zero-emission zone” is indicated (for example), may not be driven on. This is because, as soon as a predetermined accelerator pedal position AP is exceeded, the internal combustion engine is turned on with known control methods.

The accelerator pedal area indicated in the figures lies between the non-actuated accelerator pedal position AP, which corresponds to the value of 0%, and the fully actuated accelerator pedal position AP, which corresponds to the value of 100%.

In accordance with the invention, it is then provided that, upon a recognized driver's request for emission-free driving, the accelerator pedal characteristic curve is adjusted in such a manner that the maximum target drive torque (T_{target-max}) corresponds to the maximum electrical engine drive torque (T_{E-max}). The transmission of the driver's request may take place (for example) automatically or manually with a switch or the like, such that the vehicle is driven exclusively purely electrically, such that an emission-free drive is realized, since the area of hybrid driving is eliminated.

FIG. 1 shows the course of the target drive torque T_{target} over the accelerator pedal position AP in accordance with an adjusted accelerator pedal characteristic curve (I) within the framework of a first embodiment of the method. Thereby, the adjusted accelerator pedal characteristic curve based on the originally stored accelerator pedal characteristic curve with respect to the slope or the gradient, as the case may be, remains unchanged, whereas, above the maximum torque of the electrical drive, no further increase in the target drive torque T_{target} is permitted, such that, for example, at a value of 60% of the accelerator pedal position AP, the maximum target drive torque T_{target-max} is achieved, and thus corresponds to the maximum target electrical drive torque T_{E-max}. Thus, the maximum target drive torque T_{target-max} remains constant from a value of approximately 60% of the accelerator pedal position AP up to a value of 100% of the accelerator pedal position AP.

FIG. 2 shows an additional adjusted accelerator pedal characteristic curve II within the framework of a second embodiment of the method under the invention, for which the gradient or the slope, as the case may be, of the adjusted accelerator pedal characteristic curve II is changed, compared to the originally stored accelerator pedal characteristic curve, in such a manner that a value of approximately 100% of the accelerator pedal position AP is allocated, as a maximum target drive torque T_{target-max}, to the maximum electrical engine drive torque T_{E-max}. Thus, with the adjusted accelerator pedal characteristic curve II, the entire accelerator pedal area is used for electric driving, such that a type of rescaling virtually takes place. Since the slope or gradient, as the case may be, with the adjusted accelerator pedal characteristic curve II is flatter than it is with the original accelerator pedal characteristic curve, more sensitive driving without dead areas is possible over the entire accelerator pedal position area.

With the method under the invention, it is provided that the driver is able to transmit the driver's request for emission-free driving, manually with a switch or automatically. Likewise, the termination of emission-free driving may be terminated automatically or manually through a corresponding actuation of a switch, for example through a renewed actuation of a switch. Moreover, a so-called “kick-down switch” on the accelerator pedal can be used to manually transfer or terminate.

An automatic termination of emission-free driving may be determined, for example, by vehicle-related circumstances that make an end to zero-emission driving sensible. In particular, this may be the case if the electrical drive torque is not sufficient to accelerate the vehicle in the desired manner. This can be recognized, for example, by the fact that the vehicular speed or the output speed continues to decrease despite a full load of the electrical drive. In such an event, the driver may receive a message via a display or a warning light that emission-free driving has been automatically terminated. It is thereby possible that automatic termination takes place only after a predetermined period of time, such that the driver may, if necessary, react to the message and prevent the automatic termination. This may take place, for example, by the fact that the switch is actuated again, such that emission-free electric driving is maintained.

Modifications and variations can be made to the embodiments illustrated or described herein without departing from the scope and spirit of the invention as set forth in the appended claims.

1-11. (canceled)

12. A method for controlling a hybrid drive of a vehicle, wherein the hybrid drive is provided by an internal combustion engine and an electric engine, the method comprising:
defining a target drive torque requested by an operator of the motor vehicle as a function of a position of an accelerator pedal and a stored accelerator pad characteristic curve for a torque range provided by the internal combustion engine and the electric engine; and
upon receipt of the operator's request for emission-free driving, adjusting the accelerator pad characteristic curve such that a maximum target drive torque corresponds to an maximum electric engine drive torque that can be supplied by the electric engine.

13. The method as in claim 12, wherein the accelerator pad characteristic curve is adjusted such that a gradient or slope of the characteristic curve corresponds to the gradient of the original stored characteristic curve up to the adjusted maximum target drive torque, the characteristic curve held constant or flat for further advancement of the accelerator pedal.

14. The method as in claim 13, wherein the point on the characteristic curve that changes from the positive gradient to the constant value corresponds to the accelerator pedal position for maximum electric drive torque supplied by the electric engine.

15. The method as in claim 14, wherein the accelerator pedal position for maximum electric drive torque is at a value of approximately 60% of a pedal position range for the original stored characteristic curve.

16. The method as in claim 12, wherein the accelerator pad characteristic curve is adjusted such that a gradient or slope of the adjusted characteristic curve is changed as compared to the gradient of the original stored characteristic curve such that a value target drive torque for a 100% position of the accelerator pedal position corresponds to the maximum electric drive torque,

17. The method as in claim 16, wherein the gradient of the adjusted characteristic curve is less than the gradient of the original stored characteristic curve.

18. The method as in claim 12, wherein the operator's request for emission-free driving is transmitted by the operator manually or automatically via a switch.

19. The method as in claim 12, wherein an automatic operator's request for emission-free driving is indicated to the operator.

20. The method as in claim 12, wherein the operator's request for emission-free driving is terminated by the operator manually or automatically via a switch.

21. The method as in claim 20, wherein the operator's request for emission-free driving is automatically terminated upon recognition of reduced vehicle output or speed at the maximum electric drive torque.
